(19) United States
(12) Patent Application Publication
(10) Pub. No.: US 2005/0242333 A1
(43) Pub. Date: Nov. 3, 2005

(54) Automatic brake mechanism

(76) Inventor: Scott Peterson, Northborough, MA (US)

Correspondence Address: NIELDS & LEMACK, 176 EAST MAIN STREET, SUITE 7, WESTBORO, MA, 01581, US

(21) Appl. No.: 10/837,976

(22) Filed: May 3, 2004

(51) Int. Cl. B66D 5/00

(52) U.S. Cl. 254/368

(57) ABSTRACT

Braking mechanism and a winch having the braking mechanism. The braking mechanism allows a winch with which it is associated to hold a load once the winch has dragged the load up an incline. The winch includes a motor, a drive shaft selectively driven in opposite rotative directions by the motor, a gearbox, a rotatable drum and a cable wrapped around the drum. The motor provides torque, which through the gearbox turns the drum of the winch. When the motor is stopped, and the load on the cable attempts to pull the cable back off the winch drum, the torque that is fed back from the drum into the gearbox and into the drive shaft engages the brake.

### BACKGROUND OF THF INVENTION

The present invention is directed to a braking mechanism. More specifically, this invention relates to a braking mechanism having particular application in winches, especially in winches used for paying out cables and which are required to stop and maintain a load in place after the winching operation is completed.

Utility winches generally must be capable of maintaining a load in place after the winching operation is completed, such as after a load is dragged up an incline. To that end, conventional winches incorporate a brake, which is engaged as a result of the load on the winch when the motor driving the winch is stopped. For example, U.S. Pat. No. Re. 36,216 discloses an automatic brake for a winch. The '216 patent relates to a brake mechanism for a winch for controlling the unwinding play out of the winch cable when subject to a load. Brake pads are positioned to radially expand against the inner wall of the drum. A fixed and an axially movable brake shoe are positioned at the brake pads. To engage the brake, a force is applied to the movable shoe to force the shoes against the brake pads. The brake pads are correspondingly forced against the inner surface of the drum. Heat generated as a result of the braking action is absorbed by the drum, conducted to the outer surface of the drum, and dissipated to atmosphere. A spring is used to hold the assembly together, as the brake pads are otherwise loose and would become disengaged without the spring.

U.S. Pat. No. 4,545,567 discloses a winch having a three-stage planetary drive train and an automatic brake-clutch assembly. The brake-clutch allows a load to be reeled in on a cable and then holds the load when the motor driving the cable is stopped. When the load is reeled out, the brake-clutch assembly controls the rotational speed of the drum off of which the cable is deployed, to prevent it from overrunning the motor.

However, difficulties with conventional winch brake designs include high cost, excessive overheating of components, and considerable wear on components.

It therefore would be desirable to provide a braking assembly that does not require the use of multiple brake pads or a one-way clutch, and that overcomes the various drawbacks of conventional designs.

It further would be desirable to provide a braking assembly that is not dedicated to a particular apparatus, but rather functions independently of the apparatus that it is braking and is removable therefrom.

### SUMMARY OF THE INVENTION

The problems of the prior art have been overcome by the present invention, which provides a braking mechanism and a winch having the braking mechanism. The braking mechanism of the invention allows a winch with which it is associated to hold a load once the winch has dragged the load up an incline. The winch includes a motor, a drive shaft selectively driven in opposite rotative directions by the motor, a gearbox, a rotatable drum and a cable wrapped around the drum. The motor provides torque, which through the gearbox turns the drum of the winch. When the motor is stopped, and the load on the cable attempts to pull the cable back off the winch drum, the torque that is fed back from the drum into the gearbox and into the drive shaft engages the brake.

The brake avoids the application of a braking force directly to the inside surface of the rotating member or drum. Instead, a female truncated cone is fixed within the cavity of the rotating member, and is engaged by a corresponding male truncated cone for braking action. Axial actuation of the male truncated cone forces the male cone against a frictional material applied to the female truncated cone, thereby controlling the rotation of the rotating member without causing overheating of the drum. In the preferred embodiment, the design relies upon the inertia of the male cone to resist rotation when the drive shaft rotates, since the male cone is free to rotate about the shaft. When the shaft rotates and the male cone does not, sloping surfaces or cams force the male cone axially into the female cone and result in a braking action.

### BRIEF DESCRIPTION OF THE DRAWINGS

FIG. 1 is a cross-sectional view of the winch brake in accordance with the present invention;

FIG. 2A is a first end view of the brake drive coupling in accordance with an embodiment of the present invention;

FIG. 2B is a cross-sectional view of the brake drive coupling in accordance with an embodiment of the present invention;

FIG. 2C is a second end view of the brake drive coupling in accordance with an embodiment of the present invention;

FIG. 3A is an first end view of the male brake cone in accordance with the present invention;

FIG. 3B is a side view of the male brake cone in accordance with the present invention;

FIG. 3C is a second end view of the male brake cone in accordance with the present invention;

FIGS. 3D and 3E are end views of the male brake cone showing the sloping surfaces thereof in accordance with the present invention;

FIG. 3F is a side view of the cammed surface of the male brake cone of FIG. 3A;

FIG. 4A is an end view of the brake drive ramp in accordance with the present invention; and

FIG. 4B is a side view of the brake drive ramp in accordance with the present invention.

### DETAILED DESCRIPTION OF THE INVENTION

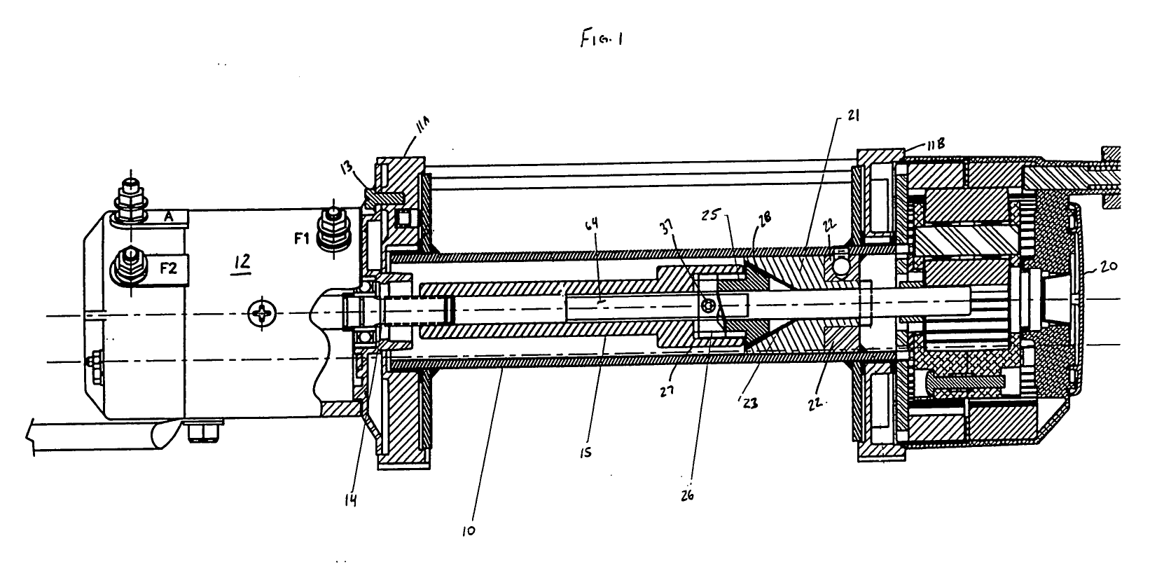

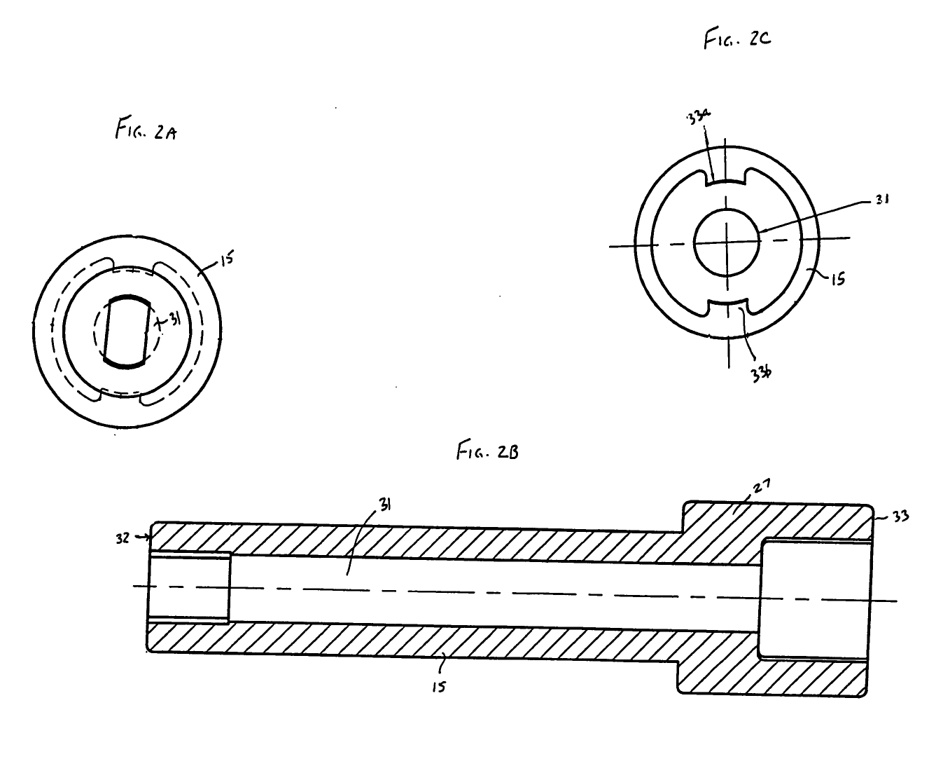

Turning to FIG. 1, the brake assembly of the present invention is shown. A rotatable hollow drum 10 is provided and is supported by supports 11A, 11B. Reversible motor 12 is mounted to the drum support 11A by any suitable means, such as one or more bolts 13. Those skilled in the art will know what types of motors are suitable for driving the drum in cable unwinding and winding directions, such motors generally including electric and hydraulic motors, with electric motors being particularly preferred. The motor includes a motor shaft 14 that extends into the cavity of the drum 10 as shown. Preferably the shaft is centrally located in the drum cavity. A brake drive coupling 15 is coupled to the motor shaft 14. With reference to FIGS. 2A, 2B and 2C, the brake drive coupling 15 is cylindrical, with the coupling body having a constant outer diameter except at a distal end 33 thereof which is substantially C-shaped and has a larger outer diameter as shown. The coupling 15 has a central bore 31 that extends through the length of the coupling 15 and receives drive shaft 64 that communicates with the gear box 20. The bore 31 has a substantially constant diameter, except at a proximal end 32 of the coupling 15 where the bore diameter is slightly larger in order to accommodate the motor shaft 14, and at the distal end 33 of the coupling 15 where the bore diameter is substantially larger in order to accommodate the male cone 26. As best seen in FIG. 2C, the enlarged bore diameter portion at the distal end 33 of the coupling 15 includes a pair of opposite tabs 33a, 33b that extend into the bore in order to lock the male cone 26 in place. Preferably the coupling 15 is a machined part (as in from round stock) or can be a cast and machined part.

Turning back to FIG. 1, mounted on drum support 11B is gearbox 20, which operably connects to the motor 12 via the motor drive shaft 14. The gearbox 20 functions to amplify the output torque of the motor in a conventional manner. Thus, the drum 10 is rotated by the motor 12 at a reduced speed relative to the rotational speed of the motor 12. Those skilled in the art will appreciate that other output amplification mechanisms can be used without departing from the spirit and scope of the present invention.

A female brake cone 21 is fixed within the drum cavity such as by press fitting a portion of the cone 21 into plug 22 that is secured, such as by welding, to the inner surface of the drum 10. The remainder of the cone 21 is cylindrical with an outside dimension matching or being slightly smaller than the inner diameter of the drum 10, so that the outside circumference of this cylinder seats against the inner surface of the drum 10. Accordingly, the female brake cone 21 rotates with the drum 10. The female brake cone 21 has an exposed inner surface that is tapered, narrowing in the direction towards gearbox 20. The exposed surface is provided with a friction material 23. Suitable frictional materials include semi-metallic materials typically used in automotive brake pads, such as powdered iron and chopped steel wool in a phenolic resin matrix, preferably with graphite and various friction enhancers added. The material can be toughened with rubber particles. The frictional material can be bonded to the surface of the cone 21 such as by cold-bonding, or more preferably is flash molded to the surface of the cone 21. Thus, the phenolic-based resin is applied to the steel female cone blank such as by spraying or brushing, and the powdered material is poured into it and pressed under heat and pressure. The phenolic resin cures under the heat and pressure, and the powdered material is solidified and adheres to the steel cone. The female brake cone 21 includes a centrally located recess through which the drive shaft 64 extends axially. The recess is dimensioned so that the drive shaft 64 does not contact the cone 21 even during rotation of the drive shaft. The tapered surfaces of the female cone 21 provide a fixed ramp for purposes described in greater detail below.

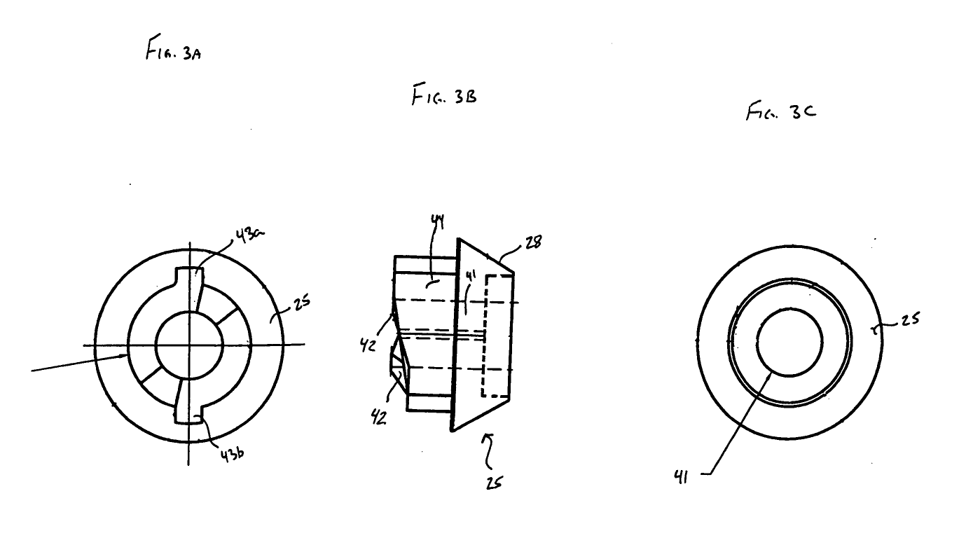

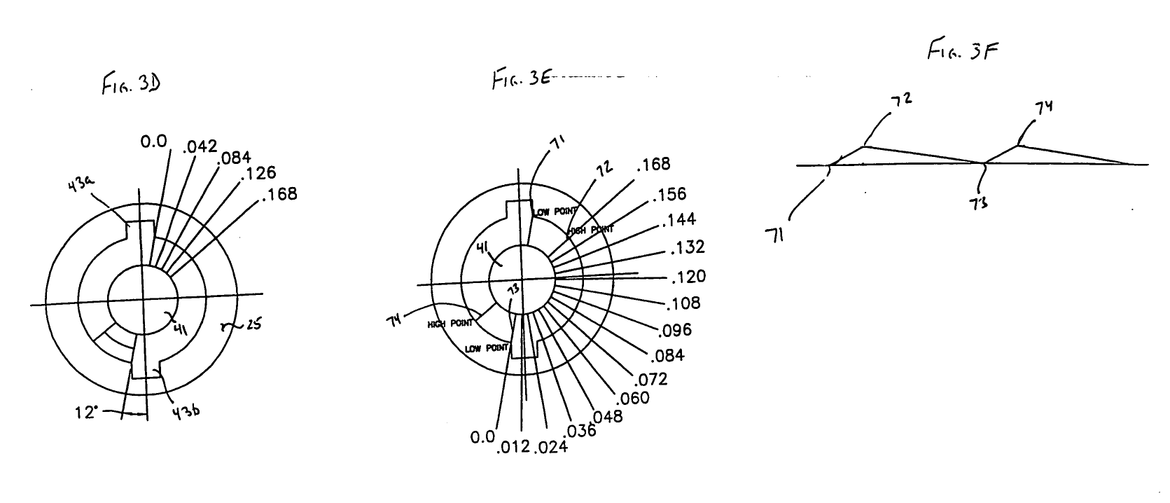

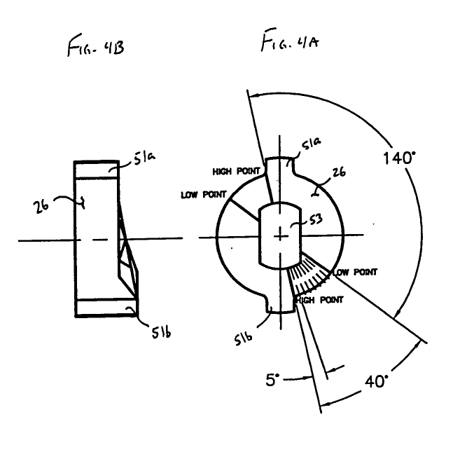

Referring now to FIGS. 3A, 3B, 3C, 3D, 3E and 3F, a movable male brake cone 25 is rotatable about the drive shaft 64 and axially movable along the drive shaft 64. The male brake cone 25 is preferably made of powdered metal and includes a centrally located recess 41 through which the drive shaft 64 extends axially. The recess 41 is dimensioned so that the drive shaft 64 does not contact the cone 25 even during rotation of the drive shaft. Although the male cone 25 can move, it cannot become displaced from the assembly because it is piloted on the shaft 64. The male brake cone 25 also includes an outer tapered surface 28 (FIG. 3B), defining a truncated cone, tapered at an angle to mate with the inner tapered surface of the female brake cone 21. The top portion of the cone is preferably hollowed out as shown, to save material cost and weight, and to provide a space for any friction material dust that may wear and come loose from the female cone and thereby avoid binding of the system. The opposite end of the male brake cone 25 is a cylindrical body 44 that terminates in sloping surfaces 42 that are configured to mate with corresponding sloping surfaces on the end of fixed brake drive ramp 26. Those skilled in the art will appreciate that although the sloping surfaces are shown as being integral to the male brake cone 25, a separate piece instead could be used that is affixed to the make brake cone 25. A pair of opposite drive dogs 43a, 43b extend radially outwardly from the cylindrical body 44 for a purpose discussed in greater detail below.

As best seen in FIGS. 3D, 3E and 3F, the sloping surfaces or cams are composed of high points (peaks) and low points (valleys) which align with corresponding low points (valleys) and high points (peaks) of the brake drive ramp 26 discussed below. Thus, beginning at the position to the right of dog 43a in FIG. 3D, a low point 71 is formed that gradually increases to a high point 72 over a 40° segment of the ramp 26. In the embodiment shown, the increase is 0.168 inches, carried out in four steps (every 100) of 0.042 inches per step. From this high point 72, there is a gradual decrease over a 140° segment until another low point 73 is reached to the left of dog 43b (FIG. 3E). This decrease is carried out in fourteen steps (every 10°) of 0.012 inches per step. This pattern is repeated from low point 73 to high point 74, again over a 40° segment, and from high point 74 to low point 71, over a 140° segment.

As seen in FIG. 1, a fixed brake drive ramp 26 is coupled to the drive shaft 64 by any suitable means, such as with a socket head cap screw 37. The drive shaft extends through slot 53 of the drive ramp 26. Since the brake ramp 26 is fixed to the drive shaft 64, it is rotatable with the drive shaft 64. FIGS. 4A and 4B show the details of the drive ramp 26. The drive ramp 26 has a substantially cylindrical body, with a pair of opposite drive dogs 51a, 51b extending radially outwardly therefrom as shown. One end face of the drive ramp 26 has sloping surfaces that define a mating cam that mates with the sloping surfaces on the end of the male brake cone 25. In the embodiment shown, the surfaces fall 0.168 inches over a 40° span, with 0.042 inch falls per 10° increments. Similarly, the surfaces rise 0.168 inches over a 140° span, with 0.012 inch rises per 10° increments. FIG. 4A shows the high (peak) and low (valley) points of the sloping surface. When the sloping surfaces of the drive ramp 26 and the male cone 25 face each other, the location of the high and low points of one can be matched to respective low and high points of the other, so that the sloping surfaces mesh together and the cone 25 nests with the ramp 26.

As mentioned above, both the male brake cone 25 and the fixed brake drive ramp 26 have respective drive dogs extending radially outward from their body portions. These drive dogs are engageable by the motor coupling 15 that is driven by the motor shaft 14. Specifically, the motor coupling 15 includes a C-shaped extension 27 (FIG. 2B) the cavity of which is deep enough to surround the fixed brake ramp 26 and the substantially cylindrical portion 44 of the male brake cone 25 that extends from the truncated cone (FIG. 1). When the motor 12 is powered, the motor coupling 15 fixed to the shaft 14 rotates and acts on the drive dogs on the fixed brake ramp 26 and the mating male brake cone 25, bringing the corresponding camming surfaces of each into or out of alignment, as the case may be. When the camming surfaces are brought out of alignment, the male brake cone 25 is forced in a direction axially away from the fixed brake ramp 26 and into pressing engagement with the inner surface of the female brake cone. Since the female brake cone 21 is fixed to the inner surface of the drum 10 and is keyed to transmit braking torque to the drum, controlling the rotation of the female brake cone 21 controls the drum rotation. The further the axial separation between the brake ramp 26 and the male brake cone 25, the greater the force with which the male brake cone engages the female brake cone 21, and the more the rotation of the drum 10 is slowed (or stopped). When the camming surfaces are brought into alignment, the male brake cone 25 nests with the brake ramp 26 and does not engage the female brake cone 21. Accordingly, the drum 10 is free to rotate.

Torque feedback through the gearbox when a load attempts to pull the cable off the drum rotates the drive shaft 64. The brake drive ramp 26 fixed to the drive shaft 64 also rotates, causing its cammed surface to rotate out of alignment with the cammed surface of the male brake cone 25, forcing the male brake cone 25 axially into the friction material in the female brake cone 21. This creates a braking force that stops the drive shaft 64 from rotating.

When the motor 12 is powered, the coupling 15 acts on the drive dogs on the brake drive ramp 26 and the male cone 25. Specifically, when winding cable about the drum, the motor coupling 15 acts on the drive dogs on the male brake cone 25, moving it axially toward the fixed brake ramp 26 until the camming surfaces of the male brake cone 25 mesh with the camming surfaces of the brake drive ramp 26, and the male cone 25 mates in nesting alignment with the fixed brake ramp 26. This releases (axially) the male brake cone from the female brake cone 21, thereby releasing the brake that is applied.

When powering cable out (unwinding), under any load, the male brake cone 25 is forced axially away from the fixed brake ramp 26 and towards the female brake cone 21, causing the brake to be (or remain) applied, thereby controlling the drum rotation and allowing the cable to be powered out slowly. More particularly, with a load applied the drive shaft turns as the load has been back-fed through the gear box, and the camming surfaces force the male cone 25 into the friction material of the female cone 21, applying the brake. In this state, the drive dogs on the brake drive ramp 26 and the male cone 25 are no longer aligned. The motor coupling 15 engages the dogs on the male cone first, before the dogs on the brake drive ramp 26 are engaged. As a result, the motor must power out against the force of the male cone 25 being forced axially in the female cone 21, slipping the brake rotationally, and thus powering out more slowly than with no load applied. The greater the load on the cable, the more axial separation there is between the brake ramp 26 and the male cone 25, and the more brake is applied, and thus the cable is powered out more slowly.

If no load is present on the cable, the male cone 25 is not driven axially into the friction material by the cams, and thus the drive dogs on the drive shaft and the male cone are aligned, the brake is not applied, and the cable is freely powered out at full speed.

Those skilled in the art will appreciate that the although in the foregoing description, the braking member that is fixed to the drum is the female brake cone and the free braking member is the male brake cone, the parts could be reversed, with the fixed braking member being male and the free braking member being female. Similarly, the particular shapes of the braking members can be modified, provided that one is frictionally engageable by the other to create a braking force upon engagement.

1. A brake for controlling the rotation of a rotating member, comprising:
a drive shaft for rotating said rotating member;
first and second braking members, said first braking member being fixed to said rotating member and having a surface adapted to be frictionally engaged by a surface of said second braking member, said second braking member having a first cammed surface and being axially movable toward said first braking member to an engaged braking position and away from said first braking member to a disengaged position;
a brake ramp fixed to said drive shaft, said brake ramp having a second cammed surface; whereupon relative rotation of said brake ramp and said second braking member in a first rotative direction causes said first and second cammed surfaces to cooperatively force said brake ramp and said second braking member axially apart, and whereupon rotation of said brake ramp in a second rotative direction causes said first and second cammed surfaces to cooperatively allow said brake ramp and said second braking member to nest.

2. The brake of claim 1, wherein said rotating member is a winch drum.

3. The brake of claim 1, wherein said first braking member comprises a female cone, and said second braking member comprises a male cone shaped to be received by said female cone.

4. A winch, comprising:
a rotatable drum adapted to wind and unwind a cable;
a reversible motor and a shaft driven by said motor;
a coupler attached to said motor shaft;
first and second braking members, said first braking member being fixed to said drum and having a surface adapted to be frictionally engaged by a surface of said second braking member, said second braking member having a first cammed surface and being axially movable toward said first braking member to an engaged braking position and away from said first braking member to a disengaged position;
a brake ramp fixed to said shaft, said brake ramp having a second cammed surface; whereupon relative rotation of said brake ramp and said second braking member in a first rotative direction causes said first and second cammed surfaces to cooperatively force said brake ramp and said second braking member axially apart, and whereupon rotation of said brake ramp in a second rotative direction causes said first and second cammed surfaces to cooperatively allow said brake ramp and said second braking member to nest.
